(19) United States
(12) Patent Application Publication
(10) Pub. No.: US 2003/0070156 A1
(43) Pub. Date: Apr. 10, 2003

(54) Device running a user interface application

(76) Inventor: Bas Jan Emile Van Rens, Eindhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 10/262,378

(22) Filed: Oct. 1, 2002

(30) Foreign Application Priority Data
Oct. 4, 2001 (EP) 01203767.7

(51) Int. Cl. G06F 9/44

(52) U.S. Cl. 717/100

(57) ABSTRACT

The invention relates to the embodiment of personality traits in user interfaces. A device according to one aspect of the invention comprises a processor (10), a memory (20) and user input/output devices (12-18), wherein the memory (20) is arranged to store a user application (30) comprising a core code and a changeable code. The changeable code portion is directed to non-functional aspects relating to user interactions and arranged to provide the user interface with a personality. Adoption of a different personality is a simple matter of modifying the changeable code or substituting a new set of changeable codes.

The invention relates to a device including a user interface and to computer programs associated with the user interface and its simulation.

In modern life, more and more people interact with electronic interfaces on a number of different levels. On a general level, such interfaces may comprise interaction with a mobile phone, a video recorder, personal computer or simple domestic appliances such as washing machines.

Of course, a primary function of such a user interface is that the interface should allow the user to gain accurate information on what a device is doing, why it may be behaving in a particular way and on giving the necessary feedback to allow the user to instruct the device to carry out a particular task, or tailor its behavior in some way. These aspects might be considered to be the functional aspects of a user interface.

Generally, such interactions between users and devices are made on the purely functional aspects described above. However, with the development of more sophisticated interfaces and more sophisticated devices and with the increasing amount of interaction that needs to go on, there is a desire to make user interfaces not only user-friendly (in terms of how information is conveyed and entered), but also user-appealing.

It is an object of preferred embodiments of the present invention to provide a user interface in which information may be conveyed to the user in a personalized manner, incorporating human-like characteristics.

According to a first aspect of the invention, there is provided a device including a user interface, the device comprising a processor, a memory and user input/output devices, wherein the memory is arranged to store a user interface application and the processor is arranged to run the application, the device being characterized in that the application comprises a core code and a changeable code, wherein the core code, when run by the processor, controls functional aspects of the device, and the changeable code is directed towards non-functional aspects concerning user interactions to provide customized output messages to a user operating the device.

Providing customizable output messages to a user of the application allows the embodiment to have user appeal added to an otherwise dull and functional user interface application. Embodying such portions in changeable code areas means that the possibility of changing the “personality” of a device is provided.

The customized output messages may comprise any form of output that the device is able to handle, for instance: a textual output, an audible output, a picture, an icon, a smell, vibrations, or movement.

The customized output messages preferably impart information to the user in a personalized manner.

Customized messages to the user may reflect chosen personality traits. For instance, information may be imparted to a user in a rude fashion (or a nasty fashion, or a sexy manner). Customized messages to a user may be arranged to reflect a particular personality of a celebrity or character, such that messages to the user are delivered in the distinctive style of the celebrity or character.

Preferably, the device is arranged to allow substitution of the changeable code associated with one personality or set of personality traits by a changeable code relating to another personality or set of personality traits to be utilized with the same core code.

Preferably, the replacement changeable code may be downloaded to the device.

Downloading of the replacement changeable code may be accomplished via e.g. the internet. Alternatively, changeable code portions may be substituted using a dial-up service.

According to a second aspect of the invention, there is provided a computer program product embodying a user interface application including a core code associated with functional aspects of a device and a changeable code directed towards non-functional aspects of the device concerning user interactions to provide customized output messages to a user operating the device.

The computer program product allows customization of a user interface of a device without affecting functionality and enables a user to change the personality of the device.

Preferably, the changeable code comprises a set of program routines which are arranged to customize user interactions with a device running the application.

The set of routines is preferably arranged to reflect particular personality traits desired to be exhibited by the device during user interactions or to reflect a particular personality of a celebrity or character, such that interactions with the user are carried out in the distinctive style of the celebrity or character.

The computer program product may comprise a plurality of sets of changeable codes, each set of changeable codes being arranged to support the same basic user interactions but exhibiting different personality traits, and wherein a user is provided with the capacity when running the program to decide which set of changeable codes to select.

Preferably, the computer program product further comprises means for directing a user towards a source of further sets of changeable codes. For instance, such a source may comprise a website.

The invention also includes the changeable code portions which may be supplied separately of the user application program.

According to a further aspect of the invention, there is provided a computer program product which, when run on a personal computer, is arranged to simulate a device incorporating a user interface in which user interactions include particular personality traits.

This aspect enables a user to evaluate, choose and construct a personality for a device to see whether that personality would be appealing to the user.

The computer program product is preferably arranged to enable a user, when running the computer program product, to evaluate whether or not a particular personality or set of personality traits are desired to be used in the device.

The computer program product preferably comprises means for substituting different personality traits and simulate their incorporation in the device.

The computer program product, upon selection of a particular personality or set of personality traits by a user, is preferably arranged to allow the transfer of changeable code portions reflecting that personality or set of personality traits to the device.

For a better understanding of the invention, and to show how embodiments of the same may be carried into effect, reference will now be made, by way of example, to the accompanying diagrammatic drawings in which:

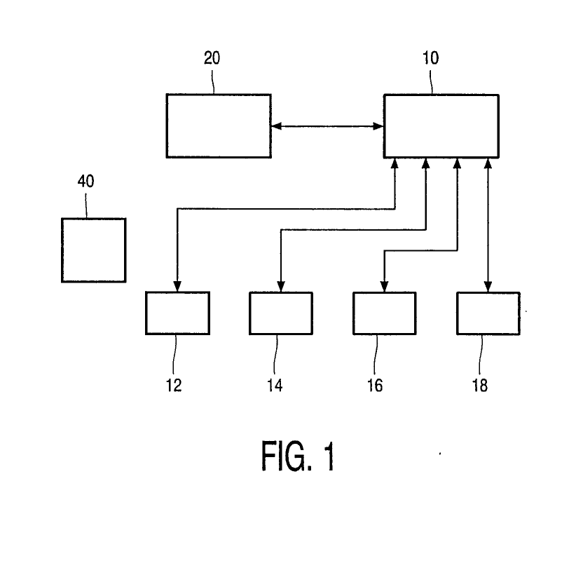

FIG. 1 illustrates an apparatus embodying a programmable personality in accordance with an aspect of the invention;

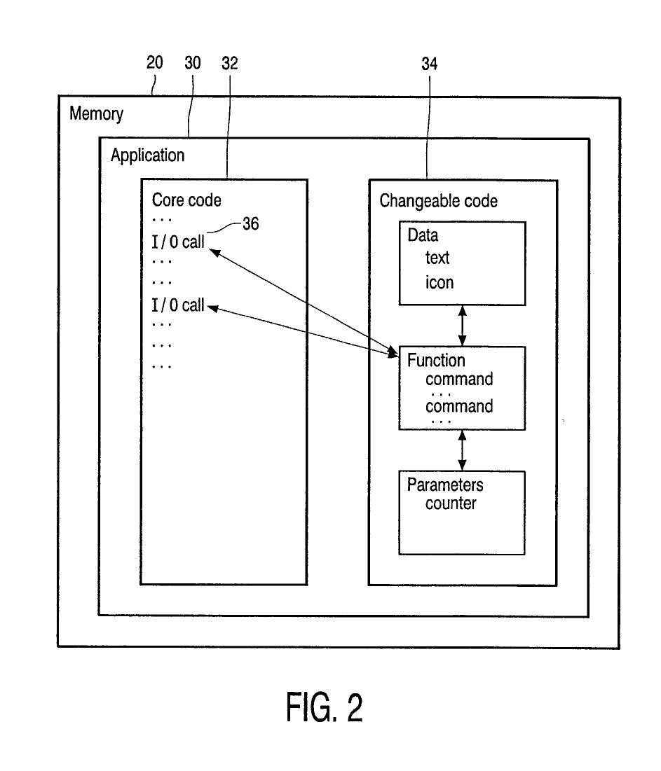

FIG. 2 is a schematic block diagram illustrating how personality may be built into a user interface program code; and

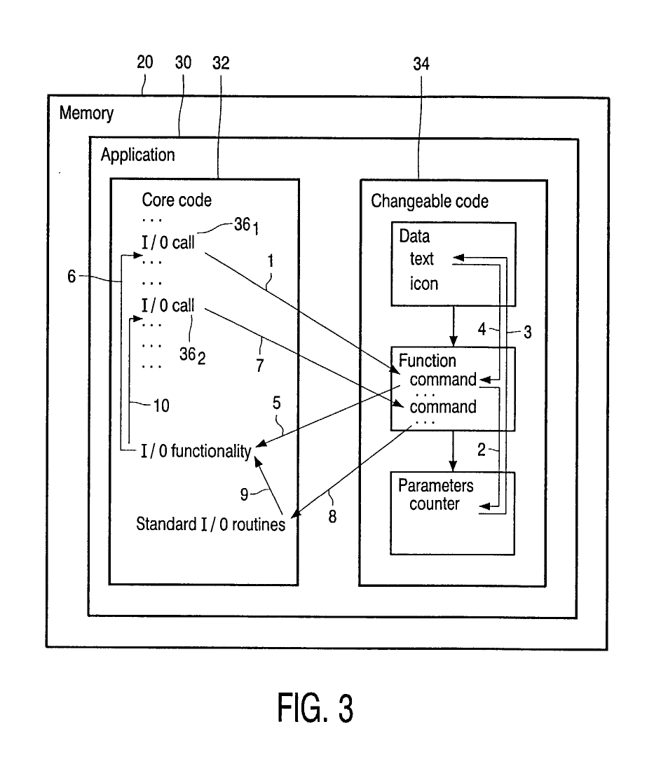

FIG. 3 illustrates the interaction of changeable code portions relating to “personality” with call functions from a user interface.

The invention provides a method and apparatus by which human characteristics or personality traits may be built into a user interface, so as to provide a more stimulating user interface. For instance, a user may choose the characteristics of the interface according to the type of interaction that the user may wish to achieve. In some cases, a user might wish to interact with a very sweet and compliant interface, other users may wish to get childish or rude responses back.

Referring to FIG. 1, there is shown a device in accordance with the first aspect of the invention with which a user may interact, the apparatus comprising a processor 10, display 12, microphone 14, speaker 16, keypad 18 and memory 20 having a user interface application 30 loaded therein. Such types of apparatus may be typically found in home computers, mobile phones and other electronic apparatus requiring an amount of processing power and a degree of user interaction.

There is also shown a computer program product 40 comprising a carrier on which a user interface application program 30 in accordance with the second aspect of the invention or a simulation program in accordance with the third aspect of the invention is storable and on which the program or programs may be supplied.

It is not important what particular function is to be achieved by the apparatus shown in FIG. 1. The present invention rather relates to the relationship between the user and the apparatus and making that relationship more interesting.

Whatever function the apparatus of FIG. 1 is arranged to carry out, a basic code relating to the functional aspects of a user interface will be stored in memory 20, processed by processor 10 and will control the outputs of the display 12 and speaker 16. The information is gathered by the apparatus from the user via input devices such as keypad 18, microphone 14.

FIG. 2 illustrates the user interface application 30, which is stored, in use, within memory 20. The application 30 comprises core code 32 and changeable code 34.

The core code 32 of the user interface application 30 contains all of the functionality of the user interface associated with the device in question. In other words, none of the functional aspects of the user application are resident in the changeable code portions 34.

In response to user inputs from microphone 14 or keypad 18 and in response to sensed conditions within the device relating to functions performed, the processor 10 will call a particular part of the core code 32 from the memory 20. At various points in the execution of the user interface application 30, the core code 32 will encounter a point at which it may make an I/O call 36 to changeable code portions 34, i.e. the points at which the interface utilizes customized response portions to exhibit “personality traits” whilst conveying any functional information required to be conveyed by the application 30.

Explaining this in more detail, for a number (and possibly all) of the I/O operations required for the user application 30, use is made of the changeable code portion 34. The changeable code portion 34 resides, together with the core code 32, in the memory 20 of the device and can be modified/updated by the user. The changeable code 34 is called by an I/O call 36 of the core code 32 and determines the manner in which the I/O operations are carried out.

Data that is to be input or output can be modified and/or supplied by the user through a function that holds one or more commands for a given I/O operation. These commands can then in turn consult a changeable data block and parameters in the changeable code portion 34.

Referring now to FIG. 3, if for a given I/O operation, the user decides to use a customized response for a particular triggering event, a set of commands shown as 1 to 6 in FIG. 3 may be followed. For other functions where the user prefers not to have a customized response, a default built-in command for that particular operation may be used by following steps 7 to 10.

A customized response will now be described.

For a customized response, an I/O call 36₁, may cause in step 1 a jump from core code 32 to changeable code 34 to initiate a command and set a counter in step 2. Customized text and/or an icon may be displayed to the user in step 3 and another command linked to in a step 4. Functional aspects of the required action may be jumped to in step 5 in the core code 32 before returning to a main function loop of the application 30 in step 6.

The counter referred to above may be an internal counter which, according to its settings determines, which one of a number of custom responses is initiated in step 3 to provide a degree of unpredictability as to how a particular action is responded to. The counter could be a random number generator or may simply be re-circulating.

In the alternate case, where it is not desired to use a customized response, the changeable code 34 may, in an I/O call 36₂, initiate steps 7 to 10 which only call the particular “function” to be performed using standard I/O routines etc.

With regard to customized responses, commands may, consist of, for example, consulting a look-up table, which resides in the data part of the changeable code 34 and contains one or more alternatives on how the function should be carried out. The command can then also involve making a choice between the alternatives, possibly based on values of counters held in the parameter part of the changeable code 34. Finally, in all variants, the command is carried out using functionality (e.g. to display a text, play a song, etc.) built into the core code 32.

Rules are programmed in a set of commands that the operating system can interpret and execute concerning the I/O functionality programmed into the core codes 32 of the application 30. An example of a command may be: “display icon”, “display movie”, “play sound file”, “read key from keypad”, “if . . . then . . . ”, “display text”.

Icons, movies, sounds and text may be stored in a data file loaded together with a function file.

A user may be able to tailor the sets of commands, using e.g. a personal computer containing a program to construct such sets dependent on the I/O functionality that is available in the core code 32 of the device and on the particular I/O operations that consult the changeable code portions 34 of the application 30. Also on the user PC, a program that simulates the device may be available for testing purposes. On completion of tailoring of the particular personality traits in customized responses according to a user's requirements, a program may be provided on the user PC to convert the sets of commands into the actual changeable code 34 that can be loaded into the memory of the device. This program then also communicates with a device for downloading of the changeable code portions and is capable of storing the changeable code 34 in a file on a disk for exchange with other personal computers.

To allow easy user programming on a user PC, there may be provided a program to choose a particular personality which will govern interactions in the device. For instance, a user may choose: “polite”; “nasty”; “sexy” or may choose particular characters such as “Bugs Bunny”. On selection of such traits, the program may then download the necessary code to the device concerned. In a particularly preferred variant, such “personalities” as Bugs Bunny or personality traits may be made available for download from internet sites or loaded into the memory on a mobile phone via a dial-up service in the same way that users may currently obtain ring tones.

An instance of typical I/O functions that could be modified to incorporate variable personality traits are “display welcome message”, “read character from keyboard”, “verify password”, “sound alarm”. Text, images, sounds, movies, etc., can be associated with each of these functions dependent on how the external function held in the memory 20 is programmed to portray a certain personality.

A possible application of this idea is the following: Josh (12) turns on his ‘standard’ mobile phone to call his friend Sarah (11). In the display, an animation of Bugs Bunny appears which says ‘What's up doc? Gimme the code’. Josh enters his code, Bugs replies ‘Nah, I think you faked it! Gimme the code”. Josh re-enters the code, even though he knows the first time was correct, but this comes with having Bugs in your phone. He goes to his phonebook and selects Sarah. The phone says ‘Ah calling Sarah again doc?’ The call is made to Sarah who has the same phone. However, her phone has her favorite Backstreet Boy telling her ‘Sarah, you have a call . . . Sarah, pick up the phone . . . etc’. Sarah answers the phone but before she can speak, the latest Backstreet jingle is played for a couple of seconds. Josh says ‘you still have that lame Backstreet stuff? I have the latest Bugs, got it yesterday off the internet’. During the conversation every once in a while Bugs interrupts ‘Are we done yet’, ‘Talking forever, aren't we?’ and at loud noises the Backstreet Boy comments ‘No need to yell’ . . . .

Both phones in the above scenario may be identical with identical functionality. However, the module that sits between these functions and the user has been programmed to assign different actions to the same functions based on a personality: in this case the snotty Bugs Bunny and the loveable Backstreet Boy. The personalities do not modify the actual functionality that is communicated (output) to the user and how the request from the user (input) is communicated to the phone, but they rather provide a certain appeal to the user.

It will be evident to the person skilled in the art that various modifications may be made without departing from the scope of the invention. The scope of the invention is merely delimited by the appendent claims.

1. A device including a user interface, the device comprising a processor (10), a memory (20) and user input/output devices (12-18), wherein the memory (20) is arranged to store a user interface application (30) and the processor (10) is arranged to run the application (30), the device being characterized in that the application (30) comprises a core code (32) and a changeable code (34), wherein the core code (32), when run by the processor (10), controls functional aspects of the device, and the changeable code (34) is directed towards non-functional aspects concerning user interactions to provide customized output messages to a user operating the device.

2. The device of claim 1, wherein the customized output messages comprise any form of output that the device is functionally capable of producing.

3. The device of claim 1, wherein the customized output messages reflect chosen personality traits to be exhibited by the device.

4. The device of claim 1, wherein the device is arranged to enable substitution of the changeable code associated with a personality or set of personality traits by a changeable code (34) relating to another personality or set of personality traits to be utilized with the same core code (32).

5. The device of claim 4, wherein a replacement changeable code (34) is downloadable to the device.

6. A computer program product (40) embodying a user interface application (30) including a core code (32) associated with functional aspects of a device and a changeable code (34) directed towards non-functional aspects of the device concerning user interactions to provide customized output messages to a user operating the device.

7. The computer program product of claim 6, wherein the product (40) allows customization of a user interface of a device without affecting functionality and enables a user to change the personality of the device.

8. The computer program product of claim 6, wherein the changeable code (34) comprises a set of program routines which are arranged to customize user interactions with a device running the application.

9. The computer program product of claim 8, wherein a set of routines is arranged to reflect particular personality traits desired to be exhibited by the device during user interactions or to reflect a particular personality, such that interactions with the user are carried out in a distinctive style.

10. The computer program product of claim 8, wherein it comprises a plurality of sets of changeable codes (34), each set of changeable codes being arranged to support the same basic user interactions but exhibiting different personality traits, and wherein a user is provided with the capacity when running the program to decide which set of changeable codes to select.

11. A changeable code (34) for use in conjunction with the computer program product of claim 6.

12. A computer program product (40) which, when run on a personal computer, is arranged to simulate a device incorporating a user interface in which user interactions include particular personality traits.

13. The computer program product of claim 12, wherein the product, when running, is arranged to enable a user to evaluate whether or not a particular personality or set of personality traits are desired to be used in the device.

14. The computer program product of claim 12, wherein the program is adapted to allow the substitution of different personality traits and simulate their incorporation in the device.

15. The computer program product of claim 14, wherein, upon selection of a particular personality or set of personality traits by a user, the product is arranged to allow the transfer of changeable code portions reflecting that personality or set of personality traits to the device.
